(19) United States
(12) Patent Application Publication
(10) Pub. No.: US 2009/0201288 A1
(43) Pub. Date: Aug. 13, 2009

(54) Rendering 3D Computer Graphics Using 2D Computer Graphics Capabilities

(76) Inventors: Amir Fischer, Tel Aviv (IL); Gershon Elber, Haifa (IL)

Correspondence Address: William S. Frommer;Frommer Lawrence & Haug, 745 Fifth Avenue, New York, NY, 10151, US

(21) Appl. No.: 11/887,310

(22) PCT Filed: Apr. 4, 2006
(86) PCT No.: PCT/IL2006/000428

§ 371 Date: Feb. 18, 2009

Related U.S. Application Data
(60) Provisional application No. 60/667,228, filed on Apr. 4, 2005.

(51) Int. Cl. G06T 15/00

(52) U.S. Cl. 345/419

(57) ABSTRACT

Method for generating and displaying 3D graphic images on the display of a terminal device using 2D graphic environments, where every possible scene is modeled by one or more objects that can be represented by polygons using a suitable modeling method. The geometry of the polygons that correspond to each object is projected for any desired orientation of the objects, onto the plane of the display. For each object, curves connecting the projections of the vertices of its corresponding mesh of polygons in all different orientations of that object and consisting of a plurality of discrete points, is created, such that every point on each curve is stored according to its (x,y) position on the plane, and such that the resolution of each curve is determined according to the number of points. A visibility analysis is performed for every mesh that corresponds to a specific orientation, thereby determining the distance of the points from the viewer. Hidden polygons and/or edges or portions thereof are deleted and the geometry for all orientations is optimally encoded. Then 3D graphic images are displayed in the 2D environments by using the encoded geometry for reconstructing a portion of, or all, the remaining polygons and filling the remaining polygons according to predefined rules.

### FIELD OF THE INVENTION

The present invention relates to the field of three dimensional (3D) computer graphics. Specifically, this invention relates to the generation and/or display of 3D computer graphics, wherein any end-user can display the 3D images on his terminal device, e.g. personal computer, cellular phone etc.

### BACKGROUND OF THE INVENTION

3D computer graphics is the art of using digital computers and specialized 3D software to create a collection of graphical objects that can be displayed on a suitable terminal. 3D computer graphics is different from 2D computer graphics in that a 3D representation of geometric data is stored in a computer for the purposes of performing calculations and executing instructions, required for rendering a collection of 2D images that are displayed and manipulated, such that a 3D illusion is obtained.

The conventional process of creating 3D computer graphics can be sequentially divided into five basic stages:
1. modeling
2. scene layout setup;
3. transformation;
4. hidden surface removal; and
5. shading and polygon(s) filling, e.g. by texture mapping.

The modeling stage can be described as shaping individual objects that are later used in the scene. Several modeling techniques are known in the art, including polygonal modeling (information related to polygonal modeling may be found for example at http://en.wikipedia.org/wiki/Polygonal_modeling). Models can be created with a wide variety of commercial modeling tools, such as AutoCAD© and Solid Works©.

Polygons are simple primitives that virtually all rendering tools use as their basic primitives. Typically, polygons are approximated from other geometric representations such as spline (curved) surfaces. Then, the scenes are typically converted into polygons, usually triangles. As would be understood by those familiar with the art of 3D graphics, a group of polygons that are connected together by shared vertices is referred to as a mesh. The main advantage of polygonal representation is that it is more efficient than other types of graphic representations for rendering and picture making needs.

Once all objects are represented by polygons in the correct orientation (i.e., the orientation, in which the user will see the desired scene) they must be displayed on the computer screen. The human eye sees three dimensions, while the computer screen can display only two dimensions, therefore, the 3D model must be converted to one or more two-dimensional image. This is often done using projection, preferably perspective projection. The basic idea behind the perspective projection is similar to the way the human eye works. Once the image is projected onto the screen, the farther objects are smaller relative to those that are closer to the eye, thus an illusion of 3D is created.

The scene layout setup stage involves arranging virtual objects, light, shading and other entities on a scene which will later be used to produce a still image or an animation. Lighting is an important factor in a scene setup. As is the case in real-world scene arrangement, lighting is a significant contributing factor to the resulting aesthetic and visual quality of the final visual effect.

During the hidden surface removal stage, visibility analysis is applied in order to determine and display only the visible portions of the 3D image created. The visibility analysis is typically done using a Z-buffer, which is one solution to the problem (visibility problem) of deciding which elements of a scene are visible, and which are hidden (information related to Z-buffers may be found for example at http://en.wikipedia.org/wiki/Z-buffering). Practically, Z-buffering is the management of image depth coordinates in 3D graphics.

When an object is rendered by a 3D graphics card, the depth of a generated pixel (z coordinate) is stored in a buffer (the Z-buffer). This buffer is usually arranged as a two-dimensional array (x-y) with one element for each screen pixel. If another object of the scene must be rendered in the same pixel, the graphics card compares the two depth values and selects the one that is closest to the observer. The chosen depth value is then saved in the Z-buffer, replacing the previous one. In the end, the Z-buffer will allow the graphics card to correctly reproduce the usual depth perception: a closer object hides a farther one.

However, implementing the Z-buffer technique in software may deteriorate the inherent capabilities of the graphic tools installed on the computer. For example, a 2D graphics package may support very efficient drawing of 2D polygons, including fast fill and efficient texture mapping. By using a Z-buffer's software emulation, those capabilities may be substantially deteriorated or even lost.

The well-known Painter's Algorithm, which is one of the simplest solutions to the visibility problem in 3D computer graphics, may also be used for visibility analysis (information related to the Painter's algorithm may be found for example at http://en.wikipedia.org/wiki/Painter's_algorithm). The painter's algorithm sorts all of the polygons in a scene by their depth and then paints them in this order, starting from the farthest polygon to the closest one. It will over-paint the parts that are normally not visible and thus solves the visibility problem.

Referring to two arbitrary polygons P and Q, the classical painter's algorithm (described, e.g., in “Computer Graphics: Principles and Practice”, by Foley et al, Addison-Wesley, 1996), performs the visibility analysis according to the following tests:
a. Test if the two polygons' x-extents (the x values that are spanned by the polygons) do not overlap. If so, order is irrelevant.
b. Test if the two polygons' y-extents do not overlap. If so, order is irrelevant.
c. Test if P is entirely on one side of Q's plane (that is, P does not intersect Q). If so, order can be determined.
d. Test if Q is entirely on one side of P's plane (that is, Q does not intersect P). If so, order can be determined.
e. Test if the projections of P and Q onto the XY plane do not overlap. If so, order is irrelevant.

Once a partial order has been defined for each pair of polygons in the scene, an order of the entire set must be determined so that painting the set of polygons in that order will leave a proper 2D image of the scene with the hidden portions removed. Such an order could be extracted from the information over all the polygons' pairs using, for example, a graph searching method.

However, the painter's algorithm can fail in certain cases. FIG. 1 illustrates a situation where polygons 1, 2 and 3 overlap each other. FIG. 5 illustrates another similar situation, relating to polygons P and Q. In both cases, it is not possible to decide which polygon is closer than the others. In order to implement the painter's algorithm in such cases, the overlapping polygons must be divided in some way to sub-polygons, so that the order of the sub-polygons can be determined.

So far we have discussed the Painter's algorithm that solves the visibility problem for a set of polygons for a single direction of view. One extension of the painter's algorithm that attempts to resolve the visibility problems from all possible views is known in the art as Binary Space Partitioning (BSP) (information related to BSP may be found for example at http://en.wikipedia.org/wiki/Binary_space_partitioning). One of the disadvantages of the BSP method is that it requires the subdivision of many polygons, and therefore greatly increases the total number of polygons that need to be processed.

3D computer graphics has become more and more dominant in many computer related fields, including scientific simulations, animation movies, and computer games. Therefore, the need for improved 3D graphics hardware and software has been growing steadily.

Some modern computers comprise hardware and software capable of presenting and/or generating 3D graphics, however, this is not true for all computers that are currently widespread the market. In addition, many applications are inherently two dimensional, e.g., the commonly used Macromedia© Flash technology. Such 2D technologies do not support 3D transformation and 3D to 2D projection. For example, the rotation of an object, e.g., a cube, while watching it from all directions may require the conversion of 3D geometry to 2D geometry, a feature that is not available in 2D graphic software packages. In addition, 2D graphic software packages are unable to resolve the hidden surface removal problem.

Computer games tend to require 3D computer graphics, as well as many computer resources. This is true also for different 3D applications that are executed on other terminal devises, e.g., cellular phones.

One way to solve the problem presented hereinabove is to implement what is known in the art as “plug-ins”. Plug-ins are software packages that are usually downloaded from the Internet in order to upgrade the capabilities of the computer. Once downloaded, the plug-ins automatically install themselves, so that users need no expertise to utilize them. However, downloading software packages from the Internet can put the computer's security at risk. Not all web sites are secure, and such downloads can infect the computer with various types of computer “viruses” and “worms”.

It would therefore be highly desirable to allow any end-user to use and enjoy 3D graphics, for example in computer games, without the need to download plug-ins and without endangering the terminal device in any other manner.

It is an object of the present invention to provide a method by which any end-user can operate 3D computer graphics on any terminal device comprising conventional 2D graphic applications.

It is another object of the present invention to provide a method that remotely provides any end-user the capability to operate 3D computer graphics and animations, over the Internet.

It is yet another object of the present invention to provide a method that allows any end-user to operate 3D computer graphics without deteriorating his terminal device's security.

It is yet another object of the present invention to provide a method that allows any end-user to operate 3D computer graphics without overloading the data channel by which that user is connected to the internet.

It is a further object of the present invention to provide a method that allows any end-user operate 3D computer graphics using the existing data rate exchange of his terminal device.

It is yet a further object of the present invention to provide an efficient process for conducting visibility analysis.

Additional purposes and advantages of this invention will become apparent as the description proceeds.

### SUMMARY OF THE INVENTION

The present invention is directed to a method for generating and displaying 3D graphic images on the display of a terminal device using 2D graphic environments, where every possible scene is modeled by one or more objects that can be represented by polygons using a suitable modeling method. The geometry of the polygons that correspond to each object is projected for any desired orientation of the objects, onto the plane of the display. For each object, curves connecting the projections of the vertices of its corresponding mesh of polygons in all different orientations of that object and consisting of a plurality of discrete points, is created, such that every point on each curve is stored according to its (x,y) position on the plane, and such that the resolution of each curve is determined according to the number of points. A visibility analysis is performed for every mesh that corresponds to a specific orientation, thereby determining the distance of the points from the viewer. Hidden polygons and/or edges or portions thereof are deleted and the geometry for all orientations is optimally encoded, e.g., by using a Minimum Spanning Tree. Then 3D graphic images are displayed in the 2D environments by using the encoded geometry for reconstructing a portion of, or all, the remaining polygons and filling the remaining polygons according to predefined rules. Filling may include texture mapping and/or painting.

The encoding stage may further include data related to the time (t) at which each point reaches a desired position.

Preferably, the visibility analysis is performed for the polygons by testing if the two polygons' x-extent does not overlap, if so, labeling the two polygons as polygons of which the display order is irrelevent; otherwise, testing if the two polygons' y-extent does not overlap, if so, labeling the two polygons as polygons of which the display order is irrelevent; otherwise, testing if the projections of both polygons onto the view plane do not overlap, if so, labeling the two polygons as polygons of which the display order is irrelevent; otherwise, testing if the first polygon is entirely on one side of the second polygon's plane, if so, determining the display order of the two polygons; otherwise, testing if the second polygon is entirely on one side of the first polygon's plane, if so, determining the display order of the two polygons; otherwise, testing to see if a separating plane between the two polygons exists, if so, determining the display order of the two polygons; otherwise, splitting polygons as necessary. These steps are repeated with the split polygons. The proper order between all polygons in the scene is found by performing a graph search over all results of the preceding steps of all possible pair of polygons, while splitting polygons as necessary. Then, the same steps are repeated for every pair of polygons in every orientation.

The visibility analysis may be performed for at least two convex polygons by: testing if the two convex polygons' x-extent does not overlap, if so, labeling the two polygons as polygons of which the display order is irrelevent; otherwise,
testing if the two convex polygons' y-extent does not overlap, if so, labeling the two convex polygons as polygons of which the display order is irrelevent; otherwise,
testing if the projections of both convex polygons onto the view plane do not overlap, if so, labeling the two convex polygons as polygons of which the display order is irrelevent; otherwise,
testing if the first convex polygon is entirely on one side of the second convex polygon's plane, if so, determining the display order of the two convex polygons; otherwise,
testing if the second convex polygon is entirely on one side of the first convex polygon's plane, if so, determining the display order of the two convex polygons; otherwise,
finding a separating plane between the two convex polygons and determining the display order of the two convex polygons;
finding the proper order between all convex polygons in the scene by performing a graph search over all the results of steps (a) to (f) of all possible pair of convex polygons, while splitting convex polygon as necessary,
wherein steps (a) to (f) are repeated for every pair of convex polygons in every orientation.

Preferably, the existence of a separating plane is tested according to the following steps:
a. defining plane L as a plane through edge eᵢ and (vertex)ⱼ wherein edges eᵢ are the edges connecting (vertex)ᵢ and (vertex)ᵢ₊₁ of the first polygon and (vertex)ⱼ is a vertex of the second polygon;
b. checking if the first polygon is on one side of L and the second polygon is on the other side of L and as long as the result is negative;
c. repeating step (b) for all combinations between edges eᵢ and vertices (vertex)ⱼ until a separating plane is found; otherwise,
d. defining plane L as a plane through edge eⱼ and (vertex)ᵢ wherein edges eⱼ are the edges connecting (vertex)ⱼ and (vertex)ⱼ₊₁ of the second polygon and (vertex)ᵢ is a vertex of the first polygon;
e. checking if the first polygon is on one side of L and the second polygon is on the other side of L, and, as long as the result is negative;
f. repeating step (e) for all combinations between edges eⱼ and vertices (vertex)ᵢ until a separating plane is found or until all combinations have been checked.

The geometry may be encoded by using a minimum spanning tree, such that for any desired n different views, n ordered lists {Ti_{|i=1, . . . , n}} of subsets of the polygonal mesh representing each view are generated. A click graph consisting of n nodes (Ni) being the n ordered lists Ti and of edges Eij connecting node i to node j_{|j=1, . . . , n} is also generated. A weight that corresponds to the cost of the difference between any two nodes Ni and Nj is assigned for each edge Eij in the click graph and the Minimum Spanning Tree (MST) of the click graph is then generated. All of the ordered lists {Ti} lists are represented by a selected order list Tk, i.e., the root of the MST, and by all the selected edges with the lowest weight that are part of the MST, and leading from Tk to all remaining ordered lists. Tk and all the transitions represented by the selected edges are encoded into a data file, from which all n ordered lists Ti can be reconstructed.

All the above and other characteristics and advantages of the invention will be further understood through the following illustrative and non-limitative description of preferred embodiments thereof.

### BRIEF DESCRIPTION OF DRAWINGS

FIG. 1 schematically shows three overlapping polygons;

FIGS. 2a, 2b, 3a and 3b schematically describe a rotating cube and the curves created from the motion of its vertices; and

FIG. 4 schematically describes two overlapping polygons in the 3D space.

### DETAILED DESCRIPTION OF PREFERRED EMBODIMENTS

In light of the drawbacks of the prior art, as described hereinabove, there is a need for an improved method by which users can be provided with 3D graphics, or with the capability to generate 3D graphics in an efficient manner in environments that only support 2D graphics.

In one embodiment of the present invention, a secure web site that offers 3D content, such as computer games and animations is provided. Any end-user, even one that possesses no 3D graphic packages, subscribed to the site can play the computer games offered while being connected to the site during playtime. Unlike the risks caused by downloading plug-ins, the website implemented in this embodiment of the present invention is secure, thus there is no security risk to the terminal device, e.g., computer or cellular phone, while the user is connected to the site.

In other embodiments of the present invention any user can be supplied with the ability to produce 3D computer graphics using the existing 2D graphic applications on his terminal device, even when he is not connected to the above-mentioned web site.

The 3D graphics used in the present invention are preferably generated in an offline preprocessing stage. According to the present invention, the images to be used in any 3D scene are modeled typically using polygonal meshes, as described hereinabove. Once the polygons are generated, they are projected onto the field of view, (i.e., the plane of the terminal device's screen). This projection is done for a discrete set of views of the objects of any scene throughout the presentation. By resolving the visibility question for a discrete set of views only, a more efficient scheme, with regard to the number of polygons splits that are necessary, is devised, in comparison to other methods, such as BSP.

In order to alleviate the difficulties stemming from the fact that only a discrete set of views is employed, changes in the position of the vertices of each polygon's, resulting from all sampled orientations are mapped into the display plane, and curves connecting the different positions of the same vertex are traced. The resolution of the changes, mapped on those curves, depends on the number of orientations sampled when producing them. Since the curves are generated by the movement of the vertices in time, in one embodiment of the present invention each point of every curve can be stored in a matrix according to its position (x,y) and optionally to time (t). That is, the memory of the terminal device contains information relating to the positions of all objects in any scene, in addition to their rate of motion. In other embodiments, only the (x,y) positions are stored in the terminal device's memory. In those embodiments, the time value is defined by other predefined rules of the game, and/or by actions of the end-user.

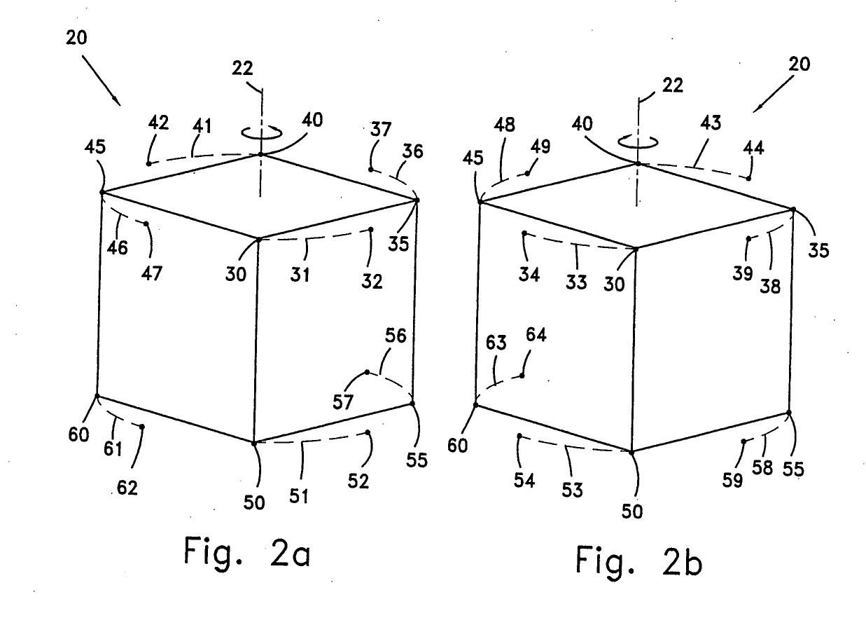

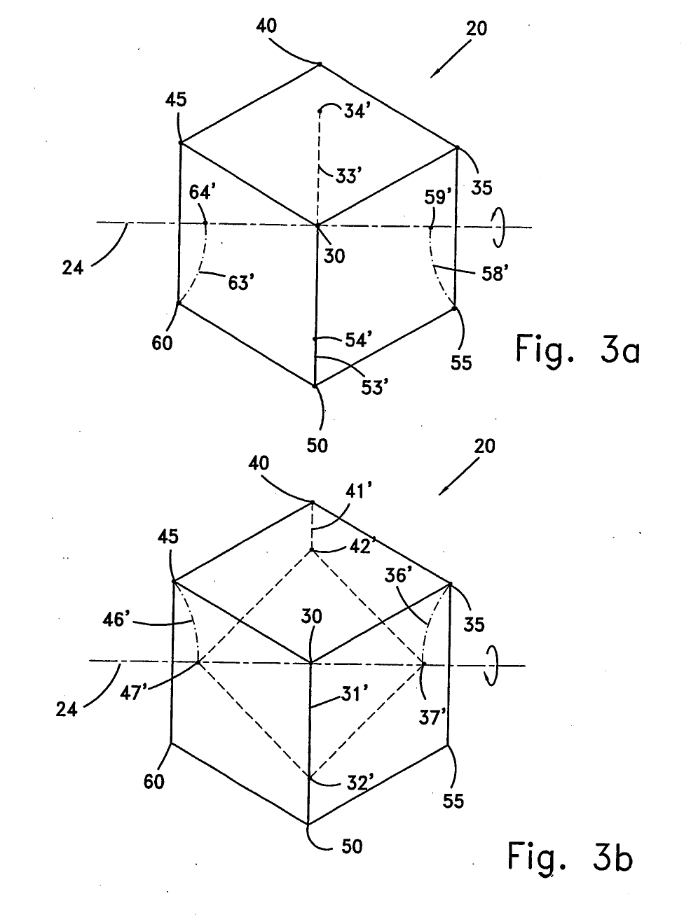

An example of such curves is described in FIGS. 2a, 2b, 3a and 3b. All of those figures describe a cube (20) which rotates. In FIG. 2a cube (20) is described as rotating 45 degrees counterclockwise around a vertical axis (22). Looking for example at the vertex in position (30) in FIG. 2a it can be seen that when cube (20) rotates 45 degrees around axis (22) the vertex at position (30) moves along curve (31), and reaches position (32). In the same manner, the vertices at positions (35), (40), (45), (50), (55), and (60) move along curves (36), (41), (46), (51), (56), and (61) to their new positions (37), (42), (47), (52), (57), and (62), respectively.

When cube (20) rotates 45 degrees clockwise along axis (22), as seen in FIG. 2b, the vertex at position (30) moves along curve (33) and reaches position (34). In the same manner, the vertices at positions (35), (40), (45), (50), (55), and (60) move along curves (38), (43), (48), (53), (58), and (63) to their new positions (39), (44), (49), (54), (59), and (64), respectively.

FIGS. 3a and 3b describes the same type of rotational motion, though in these figures cube (20) rotates along a horizontal axis (24). When rotating 135 degrees away from the viewer, as described in FIG. 3a, the vertex at position (30), for example, moves along curve (33′) until it reaches position (34′). In the same manner, vertices (50), (55), and (60) move along curves (53′), (58′) and (63′) to their new positions (54′), (59′) and (64′), respectively. The vertices at positions (35), (40), and (45) move to positions directly under positions (54′), (59′) and (64′), therefore, their movement is not shown in the drawing.

In FIG. 3b cube (20) is described as rotating 45 degrees towards the viewer along horizontal axis (24). As can be seen in FIG. 3b, the vertex at position (30), for example, moves along curve (31′) until it reaches position (32′). In the same manner, vertices (35), (40), and (45) move along curves (36′), (41′) and (46′) to their new positions (37′), (42′) and (47′), respectively. The vertices at positions (50), (55), and (60) move to positions directly under positions (37′), (42′) and (47′), therefore, their movement is not shown in the drawing.

It should be understood that the number of states, i.e., positions generated and stored in memory during preprocessing, is finite. However, once the user is supplied with the discrete (x,y) (and possible (t)) values, his terminal device can simply calculate any desired intermediate state, for example by interpolation or extrapolation.

Once the above-mentioned curves are generated, a visibility analysis is conducted for every (x,y) point, e.g., positions (30) and (32) as shown in FIG. 2a. If the time (t) was stored in memory as well as the (x,y) position, the visual analysis will be conducted for every point (x,y) at every time (t). In a preferred embodiment of the present invention, the depth analysis is conducted using a unique modification of the painter's algorithm that almost eliminates the need for polygon divisions.

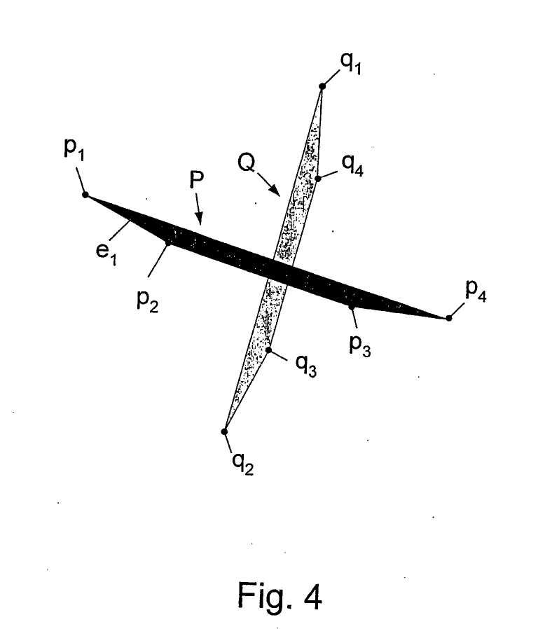

FIG. 4 shows polygons P and Q from the +Z direction wherein both polygons are almost vertical. When examining polygons P and Q according to the five tests of the classical painter's algorithm described hereinabove, it becomes apparent that all five tests will fail. Polygons P and Q overlap both in their x-extent (i.e., the x-domain that polygon P spans intersects with the x-domain that polygon Q spans) and in their y-extent, therefore, tests 1 and 2 fail. In addition, since both polygons are nearly vertical, the plane of P intersects Q, and vice versa, thus, tests 3 and 4 fail, as well. Finally, test 5 will fail since, as is seen clearly in FIG. 4, the projections of polygons P and Q onto the XY plane overlap. Since all five tests have failed, it is necessary, when using the classical painter's algorithm, to divide one of the polygons into sub-polygons so that a partial order can be determined. Only then will it be possible to arrange the polygons according to their distance from the viewer (depth value). However, it would be highly desirable to minimize the number of polygon divisions, thereby minimizing the computer resources necessary for the visibility analysis process.

In a preferred embodiment of the present invention, the number of polygon splits is minimized by adding a sixth test to the five existing tests of the classical painter's algorithm. The sixth test of the present invention checks whether a separation plane L exists, such that P is located on one side of L, and Q is located on the other. As would be understood by those familiar with the art, if such a plane exists, the determination of the order of the polygons along the Z axis becomes trivial. The search process for plane L is conducted according to the following steps:
1. Define the edges eᵢ of polygon P as the lines connecting vertices pᵢ and pᵢ₊₁ of the same polygon. For Example, as shown in FIG. 4, e₁ is the edge connecting p₁ and p₂.
2. Define L as a plane passing through edge eᵢ of P and vertex qⱼ, which is one of the vertices of polygon Q.
3. Check if P is on one side of L, and Q is on the other side. If so, the order of the polygons is determined, if not, step 2 should be repeated for all combinations between edges eᵢ and vertices qⱼ.
4. If none of the L planes generated separates P and Q completely, define eⱼ as the edges of polygon Q, and repeat step 2-3 for edges eⱼ and vertices pᵢ of P until either a separating plane has been found, or all of the combinations of edges and vertices have been checked.

As would be understood by those familiar with the art, not every pair of polygons has a separating plane. However, it is possible to prove that every pair of non-intersecting convex polygons does have a separating plane. Let M be such a separating plane that in any case does not intersect polygons P or Q. Move M along its normal line until it touches one of the vertices of either polygon, i.e. pᵢ, or qⱼ. That vertex is referred to herein as v₁. Fix M touching vertex vᵢ and rotate it around that point using the remaining two degrees of freedom. Continue to rotate M until it touches another vertex, say v₂, on either polygon. Rotate M further until it touches a third vertex on either polygon, denoted v₃. Two of the three vertices that M now touches, i.e., v₁, v₂, v₃, must be adjacent due to the convexity of the two polygons. Thus, since M passes along the edge of one polygon, and touches a vertex of the other, the above procedure that tests all edges of one polygons with a vertex of the other (and vice versa) is guaranteed to find this (transformed) M, as a separating plane.

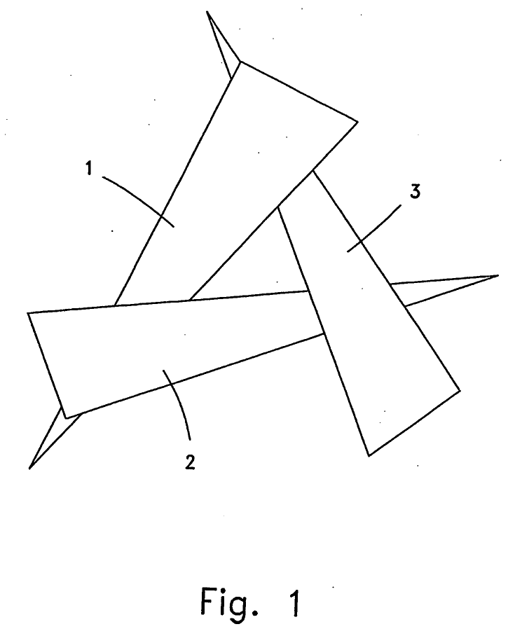

In the preferred embodiment of the present invention, the order of the tests of the classical painter's algorithm is changed. Since if any of tests 1, 2 and 5, as described hereinabove, succeed, the order of the polygons is irrelevant, in the preferred embodiment of the present invention, tests 1, 2 and 5 are performed first. Only if they all fail, tests 3 and 4, as described hereinabove, are conducted. When all 5 tests fail, the sixth test (seeking a separating plane) described hereinabove, is conducted. If all the polygons in the scene are convex and intersection-free, these 6 tests between pairs of polygons are guaranteed to succeed. In other cases (e.g. with non convex polygons), where all six tests fail, polygons will be split as described hereinabove. The tests are then performed recursively in the same manner for the split polygons. As stated above, having a determined order between each pairs of polygons could be used by those familiar with the art, via a graph search, to find a proper order of all the visible polygons so that the Painter's algorithm will produce the correct image. It should be noted that even for convex polygons, such an order might entail the need for polygon splits (See FIG. 1 for one such example).

The order of the polygons and their pattern of concealment in each scene are saved in a relatively small file. Assuming that we sample n different views (that correspond to n different orientations), each marked by Vᵢ, wherein i=1, 2, . . . , n. Each such view is encoded using a certain ordered subset of the polygons in the mesh. Any polygon that is found completely hidden in view Vᵢ is deleted from the list of polygons in that view. When considering two neighboring views, it is expected that the ordered lists of polygons in those two views will be almost similar. When switching from one view to the other, some polygons will be deleted, others will be inserted and some will change their order with regard to their distance from the viewer. Hence, we encode the n different views by taking full advantage of this spatial coherence.

Given n views with n ordered lists marked {Ti_{|i=1, . . . , n}}, of subsets of the polygonal mesh, compute the cost of the difference between any two lists, Ti and Tj_{|j=1, . . . , n} (i.e., the amount of space required to encode that difference). This difference includes deletion of (hidden) polygons no longer in the new list, insertion of new polygons and swapping the orders of some polygons. Now build a click graph (a graph with edges from every node to every other node) whose nodes are the ordered lists {Ti}, and whose edges {Eij}, where Eij is the edge from node i to node j. Edges {Eij} have corresponding weights as the delete/insert/swap encoding costs of the transition between Ti and Tj (the weight of delete and insert operations is smaller than the weight of swapping, since swapping requires encoding of changes in two indexes, i and j while delete and insert operations require encoding of changes in one index only). Then, build the Minimum Spanning Tree (MST) of this graph (information related to Minimum Spanning Tree may be found, for example, at http://en.wikipedia.org/wiki/Minimum_spanning_tree). The MST representation is the optimal representation of all {Ti} lists that are encoded into the file.

The decoder will open this MST tree and open all the {Ti} lists, as part of its initialization stage. Then, once a desired view orientation, Vi, is selected by some interaction with the viewer, the different polygons, as listed in Ti, are painted in the proper order while colors and lighting is set according to predefined shading rules, such as cosine shading, using any available 2D graphic tools.

As would be understood by those familiar with the art, the description of the different scenes of any application using the above-mentioned curves allows for smooth transitions between adjacent views using 2D graphics. Such a continuous transformation is also related to in the art as metamorphosis. Linear planar metamorphosis is highly desirable since it can be handled easily by most 2D graphics terminal devices, such as Macromedia's Flash©. Furthermore, 2D graphics generally require far fewer computer resources than 3D graphics do. In essence, all needed information is saved during the preprocessing procedure in small size files.

Another advantage to the method of the present invention is that all of the above is done during a preprocessing procedure that is made offline, so that even if in some cases it may be time consuming, it is only conducted once. In this way, while users play online, all of the graphics should be generated at high speed, using few computer resources. Practically, the data that is generated and stored for a finite number of discrete orientations allows the end-user to generate an infinite number of new orientations, while using the existing interactive tools of the conventional 2D graphic application already installed.

Although embodiments of the present invention have been described by way of illustration, it will be understood that the invention may be carried out with many variations, modifications, and adaptations, without departing from its spirit or exceeding the scope of the claims.

1. A method for generating and displaying 3D graphic images on the display of a terminal device using 2D graphic environments, comprising the steps of:
a. modeling every possible scene by one or more objects that can be represented by polygons using a suitable modeling method;
b. for any desired orientation of said objects, projecting the geometry of the polygons that correspond to each object onto the plane of said display;
c. for each object creating curves connecting the projections of the vertices of its corresponding mesh of polygons in all different orientations of that object and consisting of a plurality of discrete points, wherein every point on each curve is stored according to its (x,y) position on said plane, such that the resolution of each curve is determined according to the number of points;
d. for every mesh that corresponds to a specific orientation, performing a visibility analysis for thereby determining the distance of said points from the viewer;
e. deleting hidden polygons and/or edges or portions thereof;
f. optimally encoding the geometry for all orientations; and
g. displaying 3D graphic images in said 2D environments by using the encoded geometry for reconstructing at least a portion of the remaining polygons and filling said remaining polygons according to predefined rules.

2. A method according to claim 1 wherein the filling comprises texture mapping and/or painting.

3. A method according to claim 1 wherein the geometry is encoded by using a minimum spanning tree.

4. The method of claim 1 wherein the encoding stage further comprises data related to the time (t) at which each point reaches a desired position.

5. The method of claim 1 wherein the visibility analysis is performed for the polygons, according to the following steps:
a. testing if said two polygons' x-extent does not overlap, if so, labeling said two polygons as polygons of which the display order is irrelevent; otherwise,
b. testing if said two polygons' y-extent does not overlap, if so, labeling said two polygons as polygons of which the display order is irrelevent; otherwise,
c. testing if the projections of both polygons onto the view plane do not overlap, if so, labeling said two polygons as polygons of which the display order is irrelevent; otherwise,
d. testing if the first polygon is entirely on one side of the second polygon's plane, if so, determining the display order of said two polygons; otherwise,
e. testing if the second polygon is entirely on one side of the first polygon's plane, if so, determining the display order of said two polygons; otherwise,
f. testing to see if a separating plane between said two polygons exists, if so, determining the display order of said two polygons; otherwise,
g. splitting polygons as necessary;
h. repeating steps (a) to (g) with the split polygons; and
i. finding the proper order between all polygons in the scene by performing a graph search over all results of (a) to (h) of all possible pair of polygons, while splitting polygons as necessary,
wherein steps (a) to (h) are repeated for every pair of polygons in every orientation.

6. The method of claim 1 wherein the visibility analysis is performed for at least two convex polygons according to the following steps:
a. testing if said two convex polygons' x-extent does not overlap, if so, labeling said two polygons as polygons of which the display order is irrelevent; otherwise,
b. testing if said two convex polygons' y-extent does not overlap, if so, labeling said two convex polygons as polygons of which the display order is irrelevent; otherwise,
c. testing if the projections of both convex polygons onto the view plane do not overlap, if so, labeling said two convex polygons as polygons of which the display order is irrelevent; otherwise,
d. testing if the first convex polygon is entirely on one side of the second convex polygon's plane, if so, determining the display order of said two convex polygons; otherwise,
e. testing if the second convex polygon is entirely on one side of the first convex polygon's plane, if so, determining the display order of said two convex polygons; otherwise,
f. finding a separating plane between said two convex polygons and determining the display order of said two convex polygons;
g. finding the proper order between all convex polygons in the scene by performing a graph search over all the results of steps (a) to (f) of all possible pair of convex polygons, while splitting convex polygon as necessary,
wherein steps (a) to (f) are repeated for every pair of convex polygons in every orientation.

7. The method of claim 5 wherein the existence of a separating plane is tested according to the following steps:
a. defining plane L as a plane through edge eᵢ and (vertex)ⱼ wherein edges eᵢ are the edges connecting (vertex)ᵢ and (vertex)ᵢ₊₁ of the first polygon and (vertex)ⱼ is a vertex of the second polygon;
b. checking if said first polygon is on one side of L and said second polygon is on the other side of L and as long as the result is negative;
c. repeating step (b) for all combinations between edges eᵢ and vertices (vertex)ⱼ until a separating plane is found; otherwise,
d. defining plane L as a plane through edge eⱼ and (vertex)ᵢ wherein edges eⱼ are the edges connecting (vertex)ⱼ and (vertex)ⱼ₊₁ of said second polygon and (vertex)ᵢ is a vertex of said first polygon;
e. checking if said first polygon is on one side of L and said second polygon is on the other side of L, and, as long as the result is negative;
f. repeating step (e) for all combinations between edges eⱼ and vertices (vertex)ᵢ until a separating plane is found or until all combinations have been checked.

8. A method according to claim 3, comprising:
a. for any desired n different views, generating n ordered lists {Ti_{|i=1, . . . , n}} of subsets of the polygonal mesh representing each view;
b. generating a click graph consisting of n nodes (Ni) being said n ordered lists Ti and of edges Eij connecting node i to node j_{|j=1, . . . , n};
c. for each edge Eij in said click graph assigning a weight that corresponds to the cost of the difference between any two nodes Ni and Nj;
d. generating the Minimum Spanning Tree (MST) of said click graph;
e. representing all of said ordered lists {Ti} lists by a selected order list Tk, being the root of said MST, and by all the selected edges having the lowest weight, being part of said MST, and leading from Tk to all remaining ordered lists; and
f. encoding said Tk and all the transitions represented by said selected edges into a data file, from which all n ordered lists Ti can be reconstructed.
